(19) United States
(12) Patent Application Publication
(10) Pub. No.: US 2025/0196351 A1
(43) Pub. Date: Jun. 19, 2025

(54) ROBOT SYSTEM

(71) Applicant: FANUC CORPORATION, Yamanashi (JP)

(72) Inventor: Wataru TOOYAMA, Yamanashi (JP)

(73) Assignee: FANUC CORPORATION, Yamanashi (JP)

(21) Appl. No.: 18/839,267

(22) PCT Filed: Mar. 31, 2022
(86) PCT No.: PCT/JP2022/016931

§ 371 Date: Aug. 16, 2024

(51) Int. Cl. B25J 9/16; B25J 13/08

(52) U.S. Cl. CPC B25J 9/1666; B25J 9/163; B25J 9/1679; B25J 9/1697; B25J 13/089

(57) ABSTRACT

A robot system according to one aspect of the present disclosure comprises: a model storing unit that stores a workpiece model; a workpiece detecting unit that detects the position and orientation of a workpiece by comparing features of a surface shape measured by a three-dimensional sensor to features of the workpiece model; a workpiece model positioning unit that positions the workpiece model in a virtual space; and a path setting unit that, in the virtual space, sets a removal path so as to move and withdraw the workpiece model that is an object to be removed without interfering with another workpiece model.

### TECHNICAL FIELD

The present invention relates to a robot system.

### BACKGROUND ART

A robot system is widely used in which surface shape information of a subject such as a distance image and point cloud data is acquired and a position and a pose of a workpiece are specified by a matching process so that the workpiece is removed by a robot. In some cases, it is necessary to remove workpieces one by one in order from the workpiece arranged on the uppermost side among a plurality of workpieces arranged in a randomly overlapping manner.

When the workpiece is removed by the robot, it is necessary to determine the pose of the robot so that other workpieces, the container containing the workpieces, and the like do not interfere with the hand of the robot. It is proposed to perform an overlap determination between a recognition target and a related object by an information processing apparatus including a reception unit that receives a distance image of a subject, a recognition unit that recognizes a recognition target (workpiece) in the distance image, a conversion unit that converts information of a predetermined surface of the related object (hand) related to the recognition target into information on the distance image, and an output unit that outputs an evaluation result based on the converted information (see Patent Document 1).

### CITATION LIST

### Patent Document

Patent Document 1: Japanese Unexamined Patent Application, Publication No. 2019-116294

### DISCLOSURE OF THE INVENTION

### Problems to be Solved by the Invention

In the apparatus disclosed in Patent Document 1, the presence or absence of interference is checked by using a distance image representing a surface shape of a workpiece or a hand, but in a case where, for example, a tip of a workpiece is inserted into an opening of another workpiece, it is not possible to accurately determine the presence or absence of interference between workpieces only by a front-rear relationship of the distance image. Therefore, there is a demand for a technique capable of more reliably preventing a target workpiece and a hand holding the target workpiece from interfering with obstacles such as other workpieces when the target workpiece is removed even if the shape and arrangement of the workpiece are complicated.

### Means for Solving the Problems

A robot system according to one aspect of the present disclosure includes a robot, a three-dimensional sensor configured to measure a surface shape of a target area in which workpieces can exist, and a control device configured to generate a removal path for removing at least one of the workpieces by the robot based on the surface shape measured by the three-dimensional sensor. The control device includes a model storing unit configured to store a workpiece model obtained by modeling a three-dimensional shape of the workpieces, a workpiece detecting unit configured to detect positions and poses of the workpieces by matching a feature of the surface shape measured by the three-dimensional sensor with a feature of the workpiece model, a workpiece model positioning unit configured to position, in a virtual space, the workpiece model in the positions and the poses of the workpieces detected by the workpiece detecting unit, and a path setting unit configured to set the removal path by moving one workpiece model of the workpiece models so as not to interfere with an other workpiece model of the workpiece models in the virtual space.

### Effects of the Invention

According to the present disclosure, it is possible to prevent a target workpiece and a hand holding the target workpiece from interfering with obstacles such as other workpieces when the target workpiece is removed.

### BRIEF DESCRIPTION OF THE DRAWINGS

FIG. 1 is a schematic diagram showing the configuration of a robot system according to a first embodiment of the present disclosure;

FIG. 2 is a schematic diagram showing the removal of a workpiece in conventional art; and

FIG. 3 is a schematic diagram showing the removal of a workpiece by the robot system of FIG. 1.

### PREFERRED MODE FOR CARRYING OUT THE INVENTION

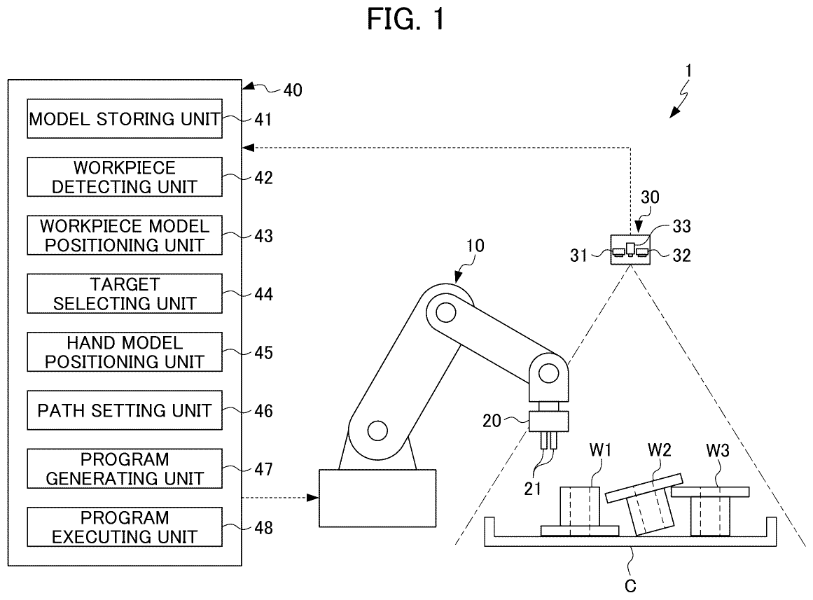

Hereinafter, an embodiment of the present disclosure will be described with reference to the drawings. FIG. 1 is a schematic diagram showing the configuration of a robot system 1 according to a first embodiment of the present disclosure. The robot system 1 removes at least one of workpieces W (hereinafter, when it is necessary to distinguish the workpieces, a number is assigned to the end of the reference numeral) randomly arranged one by one. That is, the robot system 1 removes one workpiece W among the plurality of workpieces W.

The robot system 1 includes a robot 10, a hand 20 that is attached to the distal end of the robot 10 and can hold a workpiece W, a three-dimensional sensor 30 that measures a surface shape of a target area in which the workpiece W can exist, and a control device 40 that generates an operation program of the robot 10 based on the surface shape measured by the three-dimensional sensor 30. In the shown example, the plurality of workpieces W1, W2, and W3 are short tube-shaped components of the same shape with a flange at one end.

The robot 10 determines the position and pose of the hand 20, that is, the coordinates of the reference point of the hand 20 and the orientation of the hand 20. As shown in FIG. 1, the robot 10 may be a vertical articulated robot, but is not limited thereto, and may be, for example, an orthogonal coordinate robot, a scalar robot, a parallel link robot, or the like.

The hand 20 may be any hand that can hold the workpiece W. In the shown example, the hand 20 includes a pair of finger members 21 that engage with the workpiece W by grasping the workpiece W from the outside or being inserted into the workpiece W and expanding outward. However, the present invention is not limited thereto, and the hand 20 may have another holding mechanism such as a vacuum pad that holds the workpiece W by suction.

The three-dimensional sensor 30 measures the distance, in the direction of the central axis of the field of view, of the surface on the three-dimensional sensor 30 side of each of objects (in the shown example, three workpieces W1, W2, and W3, and a tray-shaped container C on which the workpieces W1, W2, and W3 are placed) present in the field of view, from the three-dimensional sensor 30, for each position in a plane direction perpendicular to the central axis of the field of view. That is, the three-dimensional sensor 30 acquires surface shape information, such as a distance image and point cloud data of a measurement target, with which a three-dimensional image of a subject can be created.

The three-dimensional sensor 30 may include two two-dimensional cameras 31 and 32 that each capture a two-dimensional image of a measurement target, and a projector 33 that projects an image including grid-shaped reference points onto the measurement target. Such a three-dimensional sensor 30 captures images of a measurement target on which grid-shaped reference points are projected with the two two-dimensional cameras 31 and 32, and can calculate a distance from the three-dimensional sensor 30 to each grid based on a positional difference between the grids caused by parallax between the captured images of the two two-dimensional cameras 31 and 32. Alternatively, the three-dimensional sensor 30 may be a device capable of performing other three-dimensional measurements, such as a three-dimensional laser scanner.

The control device 40 includes a model storing unit 41, a workpiece detecting unit 42, a workpiece model positioning unit 43, a target selecting unit 44, a hand model positioning unit 45, a path setting unit 46, a program generating unit 47, and a program executing unit 48. The control device 40 includes, for example, a memory, a CPU, an input/output interface, and the like, and may be realized by one or more computer devices that execute appropriate programs. The components of the control device 40 are ones that fall under categorized functions of the control device 40, and do not need to be clearly distinguishable in terms of physical structure or program structure.

The model storing unit 41 stores in advance a workpiece model (for example, CAD data or the like) obtained by modeling the three-dimensional shape of the workpiece W prior to the workpiece W removal operation. It is preferable that the model storing unit 41 further stores in advance a hand model obtained by modeling the three-dimensional shape of the hand 20 and a robot model obtained by modeling the three-dimensional shape of at least the distal end portion of the robot 10. The model storing unit 41 may store a plurality of workpiece models having different shapes, and may further store an obstacle model obtained by modeling an object that may be an obstacle other than the workpiece W, such as a container C on which the workpiece W is placed.

The workpiece detecting unit 42 converts the surface shape information representing the surface shape measured by the three-dimensional sensor 30 into three-dimensional point data that can be handled in the same coordinate space as the workpiece models. The workpiece detecting unit 42 detects the position and pose of each of the workpieces W1, W2, and W3 by matching the features of the three-dimensional point data with the features of the workpiece models. Such detection of the workpieces W1, W2, and W3 can be performed by a well-known matching process. It is preferable that the workpiece detecting unit 42 also detects the position and pose of the obstacle by the matching process. As an example, in a case where the container C has a shape that could interfere with the workpiece W or the hand 20 when the workpiece W is removed, it is preferable that the workpiece detecting unit 42 also detects the position and the pose of the container C.

The workpiece model positioning unit 43 respectively positions the workpiece models in the positions and poses of the plurality of workpieces W1, W2, and W3 detected by the workpiece detecting unit 42 in a virtual space. When a removal target is selected in advance, the workpiece model positioning unit 43 preferably registers only the workpiece models of other workpieces W as obstacles, but may temporarily register the workpiece models corresponding to all the workpieces W1, W2, and W3 detected by the workpiece detecting unit 42 as obstacles. In addition, the workpiece model positioning unit 43 may further position an obstacle model such as the container C on which the plurality of workpieces W1, W2, and W3 are placed in the virtual space.

The target selecting unit 44 selects any one of the workpieces W1, W2, and W3 detected by the workpiece detecting unit 42 as a removal target. The target selecting unit 44 may select the uppermost workpiece as the removal target based on the data of the positions and poses of the workpieces W1, W2, and W3 detected by the workpiece detecting unit 42, but preferably selects the removal target by checking the workpiece models positioned in the virtual space by the workpiece model positioning unit 43. As an example, the target selecting unit 44 may select a workpiece model whose upper side (the three-dimensional sensor 30 side) is not in contact with another workpiece model as the removal target.

When the workpiece model positioning unit 43 registers the workpiece models of all the workpieces W1, W2, and W3 as obstacles, the target selecting unit 44 excludes the workpiece model as the selected removal target from the obstacles. As described above, by temporarily registering all the detected workpieces W1, W2, and W3 as obstacles and subsequently excluding a selected removal target from the obstacles, it is possible to appropriately select a removal target and to provide accurate information to the path setting unit 46. In addition, when the removal of the workpiece selected as the removal target (for example, W2) is completed, the target selecting unit 44 configured as described above can select the next removal target from the remaining workpieces (the workpieces W1 and W3) registered as obstacles, and thus it is not necessary to perform the acquisition of surface shape data by the three-dimensional sensor 30 and the matching process by the workpiece detecting unit 42 again. At this time, the target selecting unit 44 appropriately updates the information of the obstacles by excluding the workpiece model as a new removal target from the obstacles.

The hand model positioning unit 45 positions the hand model in the virtual space in a position and a pose that hold the workpiece model as the removal target. Thus, interference between the workpieces W1, W2, and W3 and the hand 20 can be checked. The hand model positioning unit 45 may generate a composite model in which the workpiece model as the removal target and the positioned hand model are combined. By generating a composite model, it is only necessary to perform a simulation for moving only a single composite model, and thus the computational load can be suppressed. The hand model positioning unit 45 may position the robot model together with the hand model. Interference between the workpieces W1, W2, and W3, the hand 20, and the robot 10 can also be checked by performing a simulation including the robot model.

The path setting unit 46 sets the removal path in the virtual space so that the workpiece model as the removal target is moved and retracted so as not to interfere with the other workpiece models, that is, the workpiece models registered as obstacles and other obstacle models. It is preferable that the path setting unit 46 moves the workpiece model of the removal target integrally with the hand model, for example, as the composite model described above, so as to retract the workpiece model as the removal target without changing the relative positional relationship between the workpiece model and the hand model. More preferably, the path setting unit 46 is configured to set the removal path so that the workpiece model, the hand model, and the robot model do not interfere with each other. The path setting unit 46 may define the removal path with a plurality of straight lines or curves joined at one or more intermediate points.

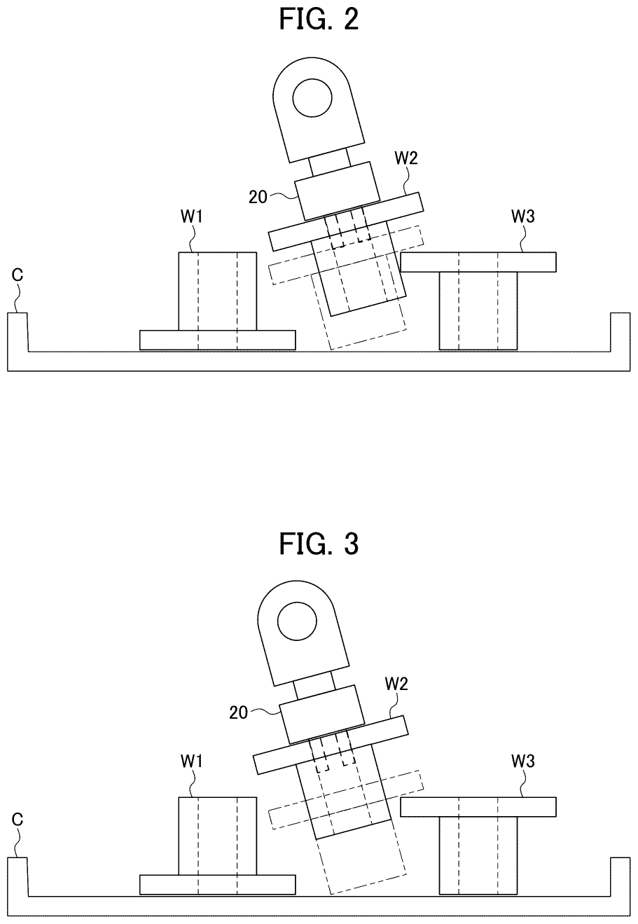

As an example, as shown in FIG. 2, when the workpiece W2, as the removal target, is lifted in the vertical direction, the short tube portion of the workpiece W2, as the removal target, interferes with the flange portion of the adjacent workpiece W3. Therefore, as shown in FIG. 3, in order to avoid interference between the workpiece W2, as the removal target, and the workpiece W1 and the workpiece W3, the path setting unit 46 sets the removal path so as to lift the workpiece W2 as the removal target in an inclined direction.

The program generating unit 47 generates an operation program of the robot 10 that moves the hand 20 along the removal path set by the path setting unit 46. Such an operation program can be generated by a well-known technique.

The program executing unit 48 operates the robot 10 in accordance with the operation program generated by the program generating unit 47. Specifically, the program executing unit 48 converts a command of the operation program into a position or a speed of each drive shaft of the robot 10 necessary for the command, generates a command value for each drive shaft of the robot 10, and inputs these command values to a servo amplifier that drives each drive shaft of the robot 10.

The robot system 1 positions the workpiece model of the workpiece W2, as the removal target, the workpiece models of the other workpieces W1 and W3 to be obstacles, and the hand model of the hand 20 holding the workpiece W2, as the removal target, in the virtual space, and sets a removal path simulated so that the workpiece model of the workpiece W2, as the removal target, and the hand model do not interfere with the workpiece models of the other workpieces W1 and W3. Therefore, the robot system 1 only needs to check interference between the hand model and the model of the obstacle whose data amount is smaller than that of the surface shape data acquired by the three-dimensional sensor 30, thus suppressing the computational load. Furthermore, since the robot system 1 uses the data from which the noise of the surface shape data acquired by the three-dimensional sensor 30 is removed, a more appropriate removal path can be set. Additionally, since the robot system 1 can take into consideration the shapes of the hidden back sides of the workpieces W1, W2, and W3 which cannot be checked with the surface shape data acquired by the three-dimensional sensor 30, a still more appropriate removal path can be set. Even in a case where workpieces having complicated shapes are arranged so as to mesh with each other and there is no workpiece that is entirely exposed, it may be possible to remove the workpieces.

Although the embodiment of the present disclosure has been described above, the present invention is not limited to the above-described embodiment. In addition, the effects described in the above-described embodiment are merely listed as advantageous effects generated from the present invention, and the effects of the present invention are not limited to those described in the above-described embodiment. As an example, the robot system according to the present invention may check only interference between the workpiece model as the removal target and workpiece models other than the removal target without using the hand model.

### EXPLANATION OF REFERENCE NUMERALS

1 robot system
10 robot
20 hand
31, 32 two-dimensional camera
33 projector
30 three-dimensional sensor
40 control device
41 model storing unit
42 workpiece detecting unit
43 workpiece model positioning unit
44 target selecting unit
45 hand model positioning unit
46 path setting unit
47 program generating unit
48 program executing unit
C container
W1, W2, W3 workpiece

1. A robot system comprising:
a robot;
a three-dimensional sensor configured to measure a surface shape of a target area in which workpieces can exist; and
a control device configured to generate a removal path for removing at least one of the workpieces by the robot based on the surface shape measured by the three-dimensional sensor,
wherein the control device has:
a model storing unit configured to store a workpiece model obtained by modeling a three-dimensional shape of the workpieces;
a workpiece detecting unit configured to detect positions and poses of the workpieces by matching a feature of the surface shape measured by the three-dimensional sensor with a feature of the workpiece model;
a workpiece model positioning unit configured to position, in a virtual space, the workpiece model in the positions and the poses of the workpieces detected by the workpiece detecting unit; and
a path setting unit configured to set the removal path by moving one workpiece model of the workpiece models so as not to interfere with an other workpiece model of the workpiece models in the virtual space.

2. The robot system according to claim 1, wherein the control device further has a target selecting unit configured to select any one of the workpieces detected by the workpiece detecting unit as a removal target.

3. The robot system according to claim 1, wherein the control device selects the one workpiece model positioned by the workpiece model positioning unit as a removal target.

4. The robot system according to claim 1, wherein
the workpiece model positioning unit registers the other workpiece model as an obstacle, and
the one workpiece model is excluded from being registered as an obstacle.

5. The robot system according to claim 1, further comprising a hand provided at a distal end of the robot, wherein
the model storing unit further stores a hand model obtained by modeling a three-dimensional shape of the hand,
the control device further has a hand model positioning unit configured to position the hand model in a position and a pose that hold the one workpiece model in the virtual space, and
the path setting unit sets the removal path so that the hand model does not interfere with the other workpiece model without changing a relative positional relationship between the one workpiece model and the hand model.

6. The robot system according to claim 5, wherein the hand model positioning unit generates a composite model in which the one workpiece model and the hand model are combined.

7. The robot system according to claim 5, wherein
the model storing unit further stores a robot model obtained by modeling a three-dimensional shape of at least a distal end portion of the robot,
the hand model positioning unit positions the robot model together with the hand model, and
the path setting unit sets the removal path so that the workpiece model, the hand model, and the robot model do not interfere with each other.

8. The robot system according to claim 1, wherein the control device further has a program generating unit configured to generate an operation program for moving the robot along the removal path set by the path setting unit.

9. The robot system according to claim 8, wherein the control device further has a program executing unit configured to operate the robot in accordance with the operation program generated by the program generating unit.
